(19) United States
(12) Patent Application Publication
(10) Pub. No.: US 2016/0021233 A1
(43) Pub. Date: Jan. 21, 2016

(54) QUICK CODE SCHEDULING FOR MOBILE DEVICES

(71) Applicant: AMX, LLC, Richardson, TX (US)

(72) Inventors: Robert Raymond Savage, Knoxville, TN (US); Rashid Skaf, Plano, TX (US)

(21) Appl. No.: 14/331,924

(22) Filed: Jul. 15, 2014

(51) Int. Cl. H04M 1/725; G06Q 10/10; H04W 4/02

(52) U.S. Cl. CPC H04M 1/72522; H04W 4/02; G06Q 10/1093

(57) ABSTRACT

Quick response or access codes may be scanned or identified by the mobile device to initiate an application access menu or user interface which provides the user device or mobile device. Instead of just performing a web link launch or other passive operation, the scanning of a QR code may provide a set of operations and user access options to further a user desired task beyond a simple access menu and data retrieval option.

### TECHNICAL FIELD OF THE APPLICATION

This application relates to accessing a quick code to invoke a scheduling application, and more particularly to viewing a scheduled event by a mobile device based on the quick code interaction.

### BACKGROUND OF THE APPLICATION

Conventionally, identifying availability for certain events requires a user to walk to the event location and determine whether availability is currently present. Also, a user may identify a website or other information resource and determine whether there is any availability, space, time slots, etc.

The conventional approach to identifying availability and access for a particular event or location requires several efforts by the user to obtain access to the information source, check the availability, and then perform a subsequent selection and also a confirmation or assurance selection to confirm the schedule has been updated to accommodate the user's request. Multiple steps or operations required to schedule an event require time and other resources.

### SUMMARY OF THE APPLICATION

One embodiment of the present application may include a method that provides receiving a quick code identifier in a request from a mobile device, accessing an application corresponding to the quick code, transmitting application information to the mobile device, receiving a schedule selection from the user device, and updating the application to include the schedule selection.

Another embodiment of the present application may include an apparatus that provides a receiver configured to receive a quick code identifier in a request from a mobile device, a processor configured to access an application corresponding to the quick code, and a transmitter configured to transmit application information to the mobile device, and wherein the receiver is configured to receive a schedule selection from the user device, and the processor is configured to update the application to include the schedule selection.

### BRIEF DESCRIPTION OF THE DRAWINGS

FIG. 1A illustrates an example network configuration of a client accessing a quick response code and invoking a scheduling function, according to example embodiments of the present application.

FIG. 1B illustrates an example logic diagram of the scheduling application, according to example embodiments of the present application.

FIG. 2A illustrates an example user interface of the scheduling application according to example embodiments.

FIG. 2B illustrates another example user interface of the scheduling application according to example embodiments.

FIG. 3 illustrates an example system diagram of a communication session between various network entities, according to example embodiments of the present application.

FIG. 4 illustrates a flow diagram of an example method according to an example embodiment of the present application.

FIG. 5 illustrates a system configuration that is configured to perform one or more operations corresponding to the example embodiments.

FIG. 6 illustrates an example network entity device configured to store instructions, software, and corresponding hardware for executing the same, according to example embodiments of the present application.

### DETAILED DESCRIPTION OF THE APPLICATION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as, packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

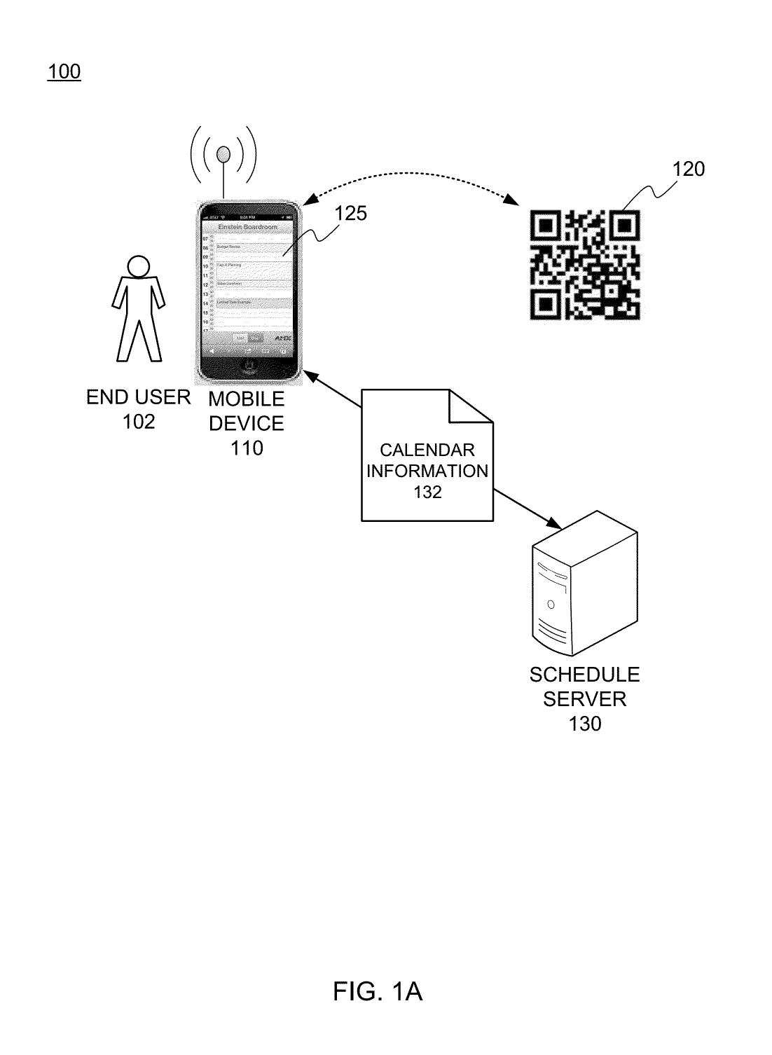

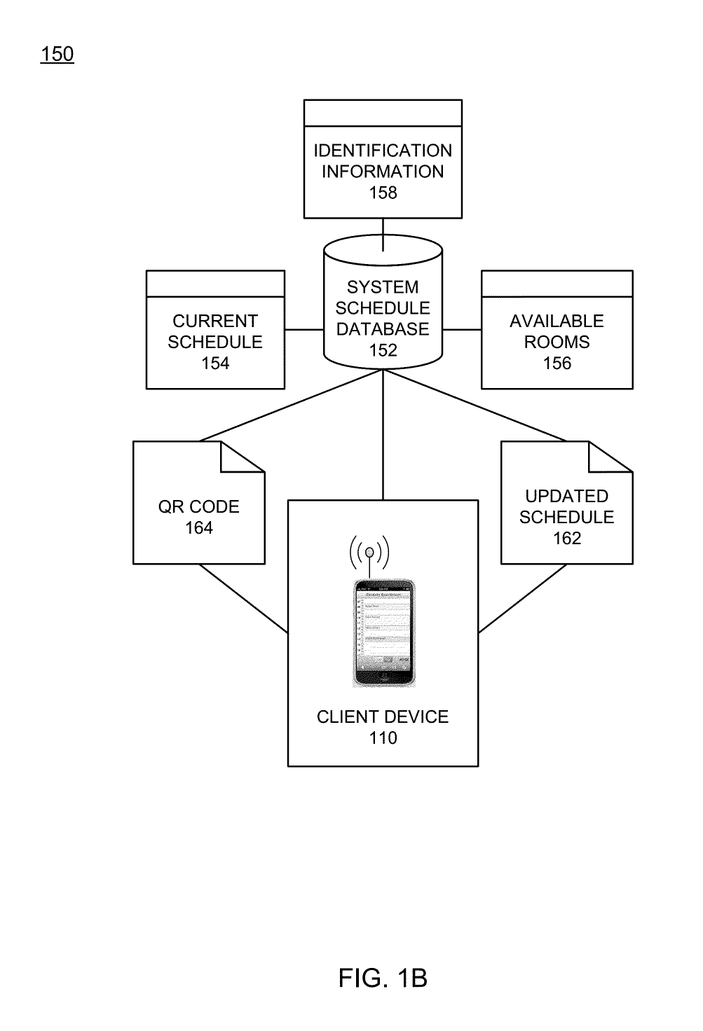

FIG. 1A illustrates an example network and corresponding use scenario 100 of a mobile device accessing a quick response code and initiating a scheduling application. Referring to FIG. 1A, the mobile device 110 may be operated by a user 102 who is seeking access to a particular venue, product, activity and/or service. The user 102 may initiate a QR code access operation by a near field technology (NFC) antenna to a receiver located near the QR code, or via a code scanning and identification effort, such as a camera function, scanning detection via a light emitted sensor or via other image detection operations or functions hosted by the mobile device 110.

According to one example, the user 102 may initiate a mobile device 110 access operation by accessing the QR code 120 which is likely mounted against the wall or is displayed on an electronic display monitor, which can be dynamically updated to accommodate changes to the code or the monitor itself. The user may engage the QR code 120 via a camera scan of the code 120 via the mobile device 110, which initiates a particular web link or mobile device application 125 on the mobile device 110. Once the QR code data is received by the mobile device 110, the mobile device may automatically invoke an application for a calendar or other scheduling application that enables the user to be identified and select an access option to the venue. For this example, a user may be attempting to setup a time to access a conference room that is identified by the QR code. The QR code may identify the conference room among other conference rooms by name, the QR code may also trigger a communication session establishment message from the mobile device to a server which retrieves schedule information from a database or schedule server 130 and shares that schedule or calendar information 132 with an application on the mobile device 110. The information may include available time slots, blocked time slots or other information related to the access of that particular conference room.

The QR code being accessed could trigger a digital data extraction that matches the QR identifier to a particular location stored in a database (i.e., conference room ‘A’). The information may also provide an application trigger and user preferences which are stored separately from the application. For example, the application may invoke a calendar schedule for that particular conference room. User preferences may be invoked to automatically populate the calendar with a calendar selection awaiting approval. For example, if the user history information or user preferences are based on earliest times, then the calendar application may access the preferences/history and identify an earliest time available for that conference room associated with the QR code.

The device may be using an ISO/IEC 18004:2006 standard for QR code identification and protocol establishment. Accessing the code may launch a web-based control application that may be used to control wireless enabled and/or web enabled devices in the conference room, such as lights, video projectors, drop-down screens, automatic window blinds, motor controlled demonstration platforms, etc. The conference room schedule uniform resource locator (URL) is generally static but may be updated periodically based on the server trolling cycle (e.g., 15 minutes, 20 minutes, etc.). The scheduling information will be current within that defined trolling period. As a result, the URL will not need to be changed and the QR code will function as required. The user access and rights to use the application may provide components necessary to manage the user access attempts and provide the user access rights on a room-to-room basis. The schedule server 130 may provide anonymous access to the mobile scheduling web application. Anonymous access in the system is implemented using the ‘GUEST’ account and ‘GUEST’ permissions. The server administrator can enable the GUEST account to effectively permit anonymous access to the web application(s) so access may be provided. The calendar application 132 is pre-stored in the schedule server 130.

FIG. 1B illustrates an example logic diagram of the logic functions and controls of the application used to schedule the events. Referring to FIG. 1B, the system 150 includes a schedule database 152, which may store schedule information and provide information to the logic modules or scripts used to identify the current schedule 154, the identification information 158 of the users, the available rooms 156, the QR codes received 164, and the updated schedule 162 once a user device 110 selection has been processed and received.

The user authentication may be performed by a persisted authentication token/cookie. In operation, the application can authenticate returning users based on a previous login session. The “Sign On” prompt/page may include an optional “Remember Me” option that, if checked, the web application will persist a session authentication token as an encrypted browser cookie. Upon subsequent access to the mobile scheduling web application, the user authentication token can be provided to the server 152 to validate the user's identity and grant the user access without requiring the user to resubmit their credentials. This user authentication token/cookie will expire after a predetermined time frame (e.g., 5 day, 10 days, 30 days, etc.) of non-use or renew its expiration date if the user accesses the mobile scheduling web application within the expiration window. Examples of the scheduling application information may include start/end time, organizer name, subject, attendees, and message. According to other examples, separate schedules for separate entities could also be presented, such as “are you an office space renter/temporary associate”, “a motivational speaker”, “a fitness instructor”, etc.

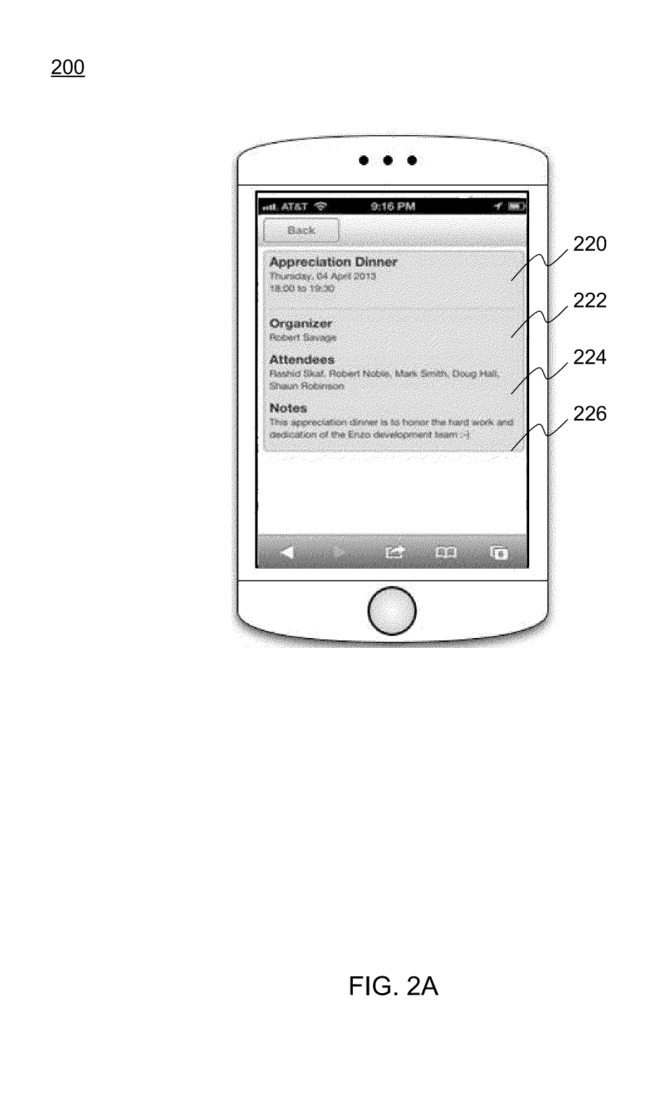

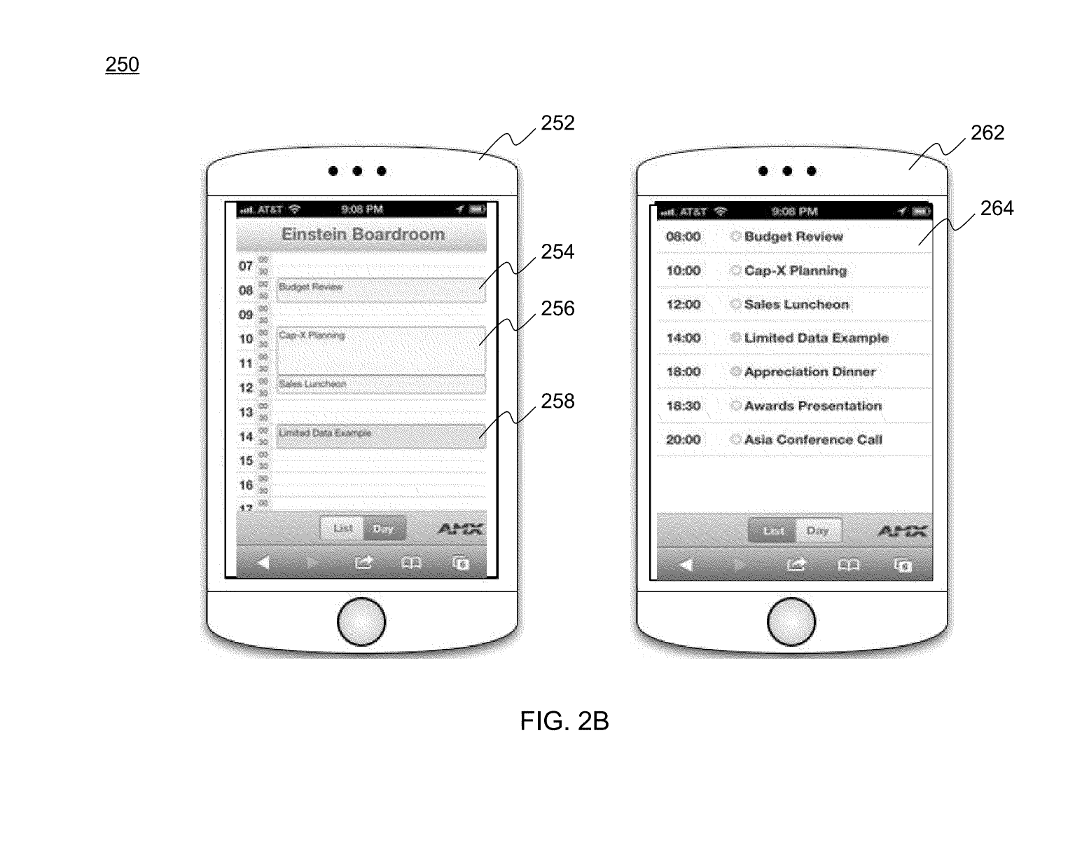

FIG. 2A illustrates an example user interface of the scheduling application on the user device (e.g., smartphone), according to example embodiments. Referring to FIG. 2A, the user interface 200 includes a set of menu options related to scheduling a conference room. In this example, the user interface option 220 includes a topic or main purpose of the event “appreciation dinner” with other parameters, such as date, time, location, etc. The parameters may be retrieved from different user profiles and related information sources and combined into a single user interface menu based on other users' selections and requests. The organizer 222 may be the user who initiated the event, which is by default the first user to select the event and setup the event in the calendar application. The attendees 224 may include all of the users who are signed up to attend the event or who may have selected the conference room at a particular time frame that overlaps the scheduled event, and who are also certified or authorized to attend the event. Lastly, the notes section 226 may be provided by any of the users who are interested in identifying the event or sharing comments about the event.

FIG. 2B illustrates an example user interface of the scheduling application on the user device (e.g., smartphone), according to example embodiments. Referring to FIG. 2B, the user interfaces 250 include a set of menu options related to scheduling a conference room. In this example, the user interface options of the first menu 252 may illustrate a calendar of a particular conference room. As may be observed, multiple calendar entries 254-258 are illustrated as being part of the day events on the calendar for one particular conference room. This provides an authorized user to access the master calendar stored on the scheduling server and add an event time for their event. Some users may have administrative privileges so that the user can change others scheduled events based on seniority or due to scheduling conflicts. However, the default user can only add to available time slots and cannot otherwise make modifications to existing time slots. The other example user interface 262 shows a list of times 264 for easier viewing so the user can observe the daily activities and which ones are part of his or her schedule.

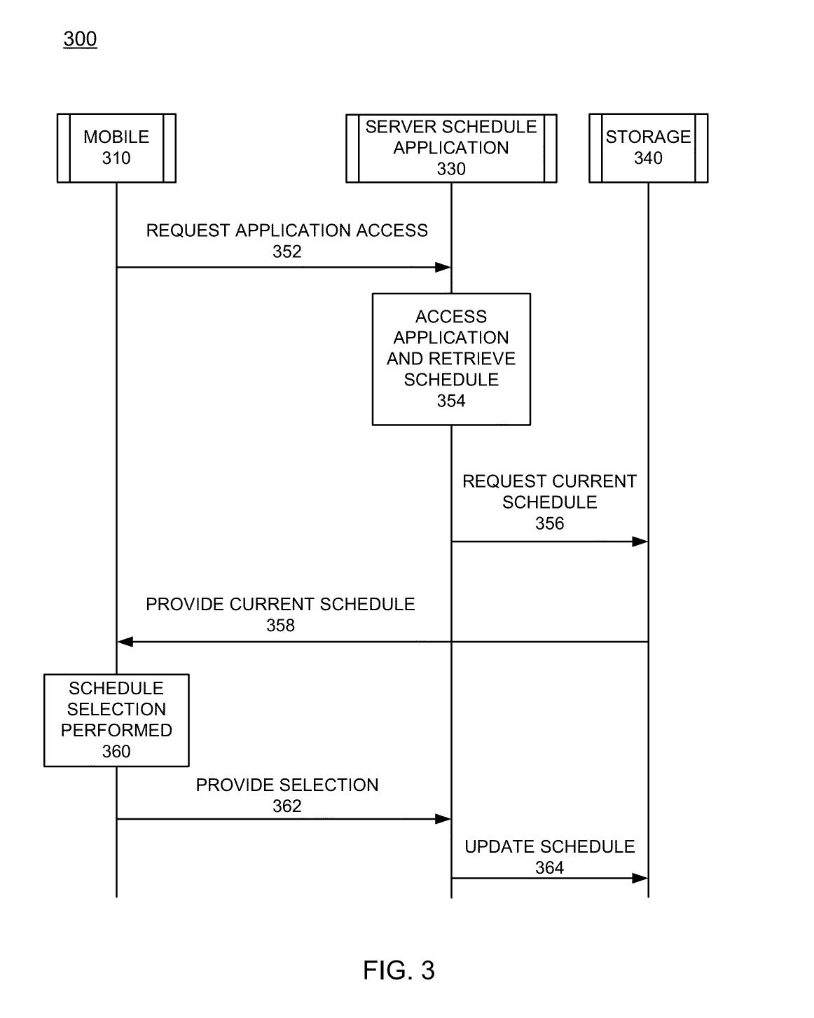

FIG. 3 illustrates an example system signaling diagram according to example embodiments. Referring to FIG. 3, the mobile device 310 may be accessing an application 330 on a server that is operated separately from the user device or which is a plug-in agent that operates on the user device and communicates with a server or storage database 340. In one example mode of operation, the mobile device 310 may scan a quick response (QR) code and may transmit a quick code identifier in a request message to the scheduling application 330. The request may include an application access request 352. The application may then access a database application corresponding to the quick code and identify an event status based on the quick code including a request for schedule information 354. The request may be transmitted 356 to storage 340 to identify the calendar information. The event status information may then be transmitted to the user device, which initiates a scheduling application that may receive a schedule selection from the user device, and update the database application to include the schedule selection. The quick code may provide a location identifier and a type of application used to access a scheduling function for that specific location. The quick code identifier provides the location identifier of a particular conference room. The type of application may be a scheduling calendar application. The current schedule can be provided 358 to the user device 310 for user access. The information received from the user device may include a selection, an automated selection based on user preferences and other information used to make a schedule selection 360. The selection 362 can then be transmitted to the server 330 which updates the schedule accordingly 364.

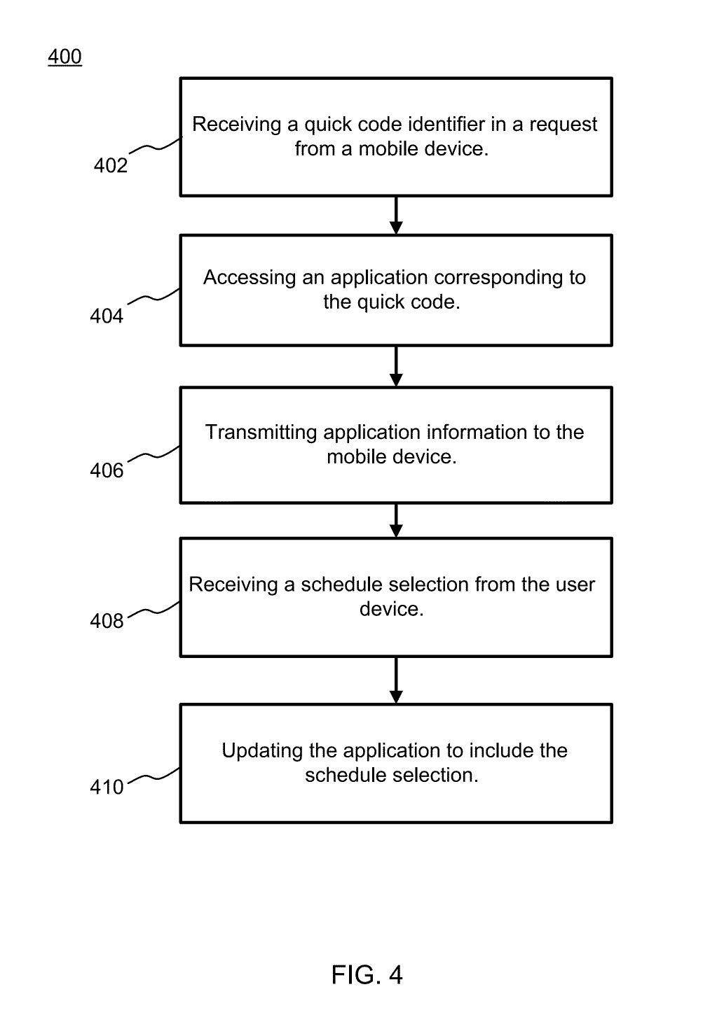

FIG. 4 illustrates a flow diagram of an example method of operation according to example embodiments. Referring to FIG. 4, the method 400 may provide receiving a quick code identifier in a request from a mobile device, at operation 402 and accessing an application corresponding to the quick code at operation 404. The method may also include transmitting application information to the mobile device, receiving a schedule selection from the user device, and updating the application to include the schedule selection.

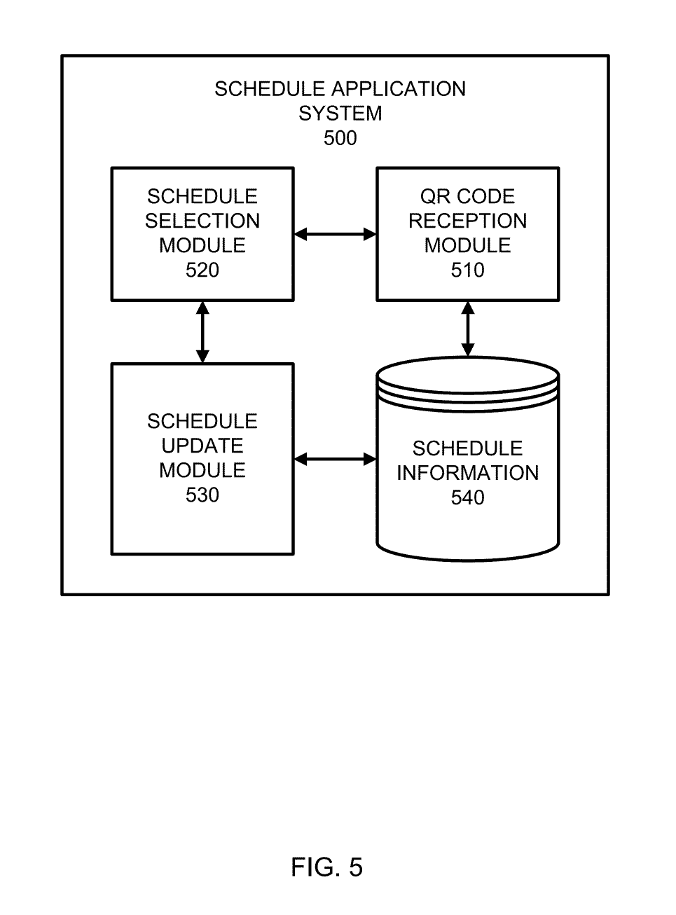

FIG. 5 illustrates an example system 500 used to perform any of the above-noted methods of operation or similar functions shared by example embodiments described herein. For example, the schedule system 500 may be a stand-alone device or a combination of devices working in unison to perform a particular function. Also, the modules may be hardware and/or software configured to perform one or more operations in furtherance of the particular function. In operation, the QR code reception module 510 may receive a QR code scan from a mobile device. The information may trigger schedule information 540 to be accessed to identify a present schedule. The schedule selection module 520 may access an application corresponding to the quick code and receive a schedule selection from the user device. The update module 530 may update the application to include the schedule selection.

The quick code may provide a location identifier and a type of application to be accessed. The quick code identifier provides the location identifier of a particular conference room and the application includes a scheduling calendar application. The system may also provide identifying a present schedule based on the location identifier of the particular conference room, retrieving user preferences for scheduling an event, applying the user preferences to a scheduling function that considers multiple variables, including the user preferences, availability of the room, user priority (e.g., low, medium, high), user status (e.g., active, in-active, contractor, employee, senior employee, etc.). The application may then automatically select a time slot for the user device or user based on the user preferences being applied to the scheduling function. As a result, the user profile may be applied to the scheduling function. The user can be authenticated and the user profile priority may be applied to the scheduling function to automatically select the time slot for the user. The application may receive confirmation from the user device of the selected time slot, and update the calendar application to include the selected time slot.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

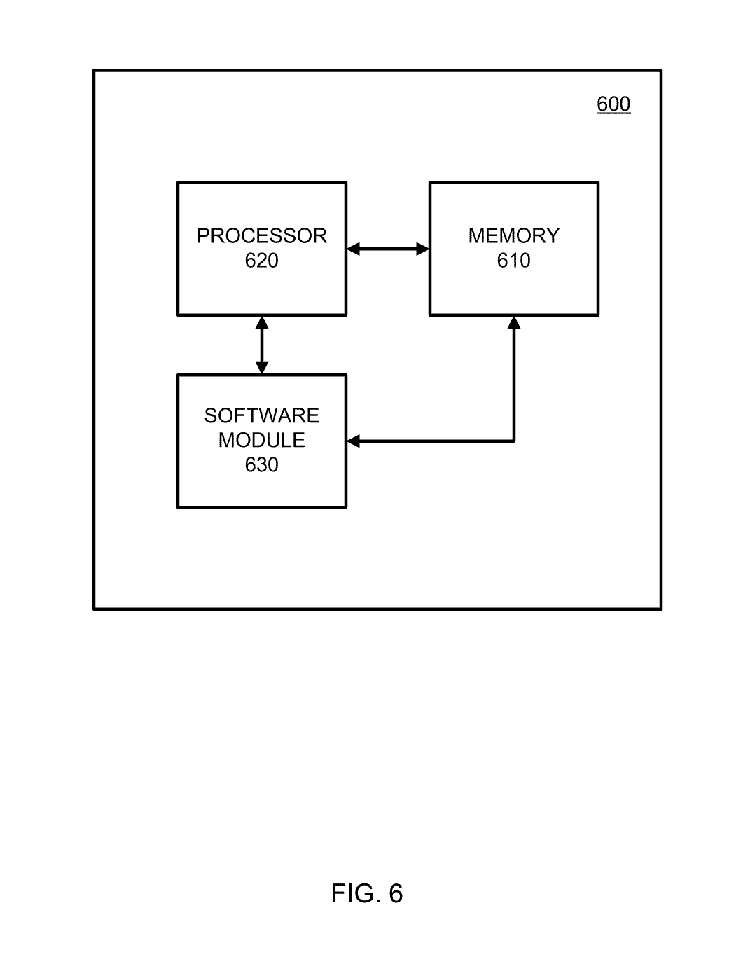

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example FIG. 6 illustrates an example network element 600, which may represent any of the above-described network components, etc.

As illustrated in FIG. 6, a memory 610 and a processor 620 may be discrete components of the network entity 600 that are used to execute an application or set of operations. The application may be coded in software in a computer language understood by the processor 620, and stored in a computer readable medium, such as, the memory 610. The computer readable medium may be a non-transitory computer readable medium that includes tangible hardware components in addition to software stored in memory. Furthermore, a software module 630 may be another discrete entity that is part of the network entity 600, and which contains software instructions that may be executed by the processor 620. In addition to the above noted components of the network entity 600, the network entity 600 may also have a transmitter and receiver pair configured to receive and transmit communication signals (not shown).

Although an exemplary embodiment of the system, method, and computer readable medium of the present invention has been illustrated in the accompanied drawings and described in the foregoing detailed description, it will be understood that the invention is not limited to the embodiments disclosed, but is capable of numerous rearrangements, modifications, and substitutions without departing from the spirit or scope of the invention as set forth and defined by the following claims. For example, the capabilities of the system of FIG. 5 can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the invention, as generally described and illustrated in the figures herein, may be arranged and designed in a wide variety of different configurations. Thus, the detailed description of the embodiments is not intended to limit the scope of the invention as claimed, but is merely representative of selected embodiments of the invention.

One having ordinary skill in the art will readily understand that the invention as discussed above may be practiced with steps in a different order, and/or with hardware elements in configurations that are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method comprising:
receiving a quick code identifier in a request from a mobile device;
accessing an application corresponding to the quick code;
transmitting application information to the mobile device;
receiving a schedule selection from the user device; and
updating the application to include the schedule selection.

2. The method of claim 1, wherein the quick code provides a location identifier and a type of application.

3. The method of claim 2, wherein the quick code identifier provides the location identifier of a particular conference room.

4. The method of claim 2, wherein the application comprises a scheduling calendar application.

5. The method of claim 2, further comprising:
identifying a present schedule based on the location identifier;
retrieving user preferences for scheduling an event;
applying the user preferences to a scheduling function; and
automatically selecting a time slot for the user device based on the user preferences being applied to the scheduling function.

6. The method of claim 5, further comprising:
applying a user profile associated with the user device to the scheduling function;
authenticating the user device based on the user profile;
applying a user profile priority to the scheduling function; and
automatically selecting the time slot for the user device based on the user profile priority and the user preferences being applied to the scheduling function.

7. The method of claim 1, further comprising:
receiving confirmation from the user device of the selected time slot; and
updating the calendar application to include the selected time slot.

8. An apparatus comprising:
a receiver configured to receive a quick code identifier in a request from a mobile device;
a processor configured to
access an application corresponding to the quick code; and
a transmitter configured to transmit application information to the mobile device, and wherein the receiver is configured to receive a schedule selection from the user device, and the processor is configured to update the application to include the schedule selection.

9. The apparatus of claim 8, wherein the quick code provides a location identifier and a type of application.

10. The apparatus of claim 9, wherein the quick code identifier provides the location identifier of a particular conference room.

11. The apparatus of claim 9, wherein the application comprises a scheduling calendar application.

12. The apparatus of claim 9, wherein the processor is further configured to identify a present schedule based on the location identifier, retrieve user preferences for scheduling an event, apply the user preferences to a scheduling function, and automatically select a time slot for the user device based on the user preferences being applied to the scheduling function.

13. The apparatus of claim 12, wherein the processor is further configured to apply a user profile associated with the user device to the scheduling function, authenticate the user device based on the user profile, apply a user profile priority to the scheduling function, and automatically select the time slot for the user device based on the user profile priority and the user preferences being applied to the scheduling function.

14. The apparatus of claim 8, wherein the receiver is further configured to receive confirmation from the user device of the selected time slot, and update the calendar application to include the selected time slot.

15. A non-transitory computer readable storage medium configured to store instructions that when executed cause a processor to perform:
receiving a quick code identifier in a request from a mobile device;
accessing an application corresponding to the quick code;
transmitting application information to the mobile device;
receiving a schedule selection from the user device; and
updating the application to include the schedule selection.

16. The non-transitory computer readable storage medium of claim 15, wherein the quick code provides a location identifier and a type of application.

17. The non-transitory computer readable storage medium of claim 16, wherein the quick code identifier provides the location identifier of a particular conference room.

18. The non-transitory computer readable storage medium of claim 16, wherein the application comprises a scheduling calendar application.

19. The non-transitory computer readable storage medium of claim 16, wherein the processor is further configured to perform:
identifying a present schedule based on the location identifier;
retrieving user preferences for scheduling an event;
applying the user preferences to a scheduling function; and
automatically selecting a time slot for the user device based on the user preferences being applied to the scheduling function.

20. The non-transitory computer readable storage medium of claim 19, wherein the processor is further configured to perform:
applying a user profile associated with the user device to the scheduling function;
authenticating the user device based on the user profile;
applying a user profile priority to the scheduling function;
automatically selecting the time slot for the user device based on the user profile priority and the user preferences being applied to the scheduling function;
receiving confirmation from the user device of the selected time slot; and
updating the calendar application to include the selected time slot.
